(19) United States
(12) Patent Application Publication
(10) Pub. No.: US 2014/0291949 A1
(43) Pub. Date: Oct. 2, 2014

(54) Device and Method to Move a Bale of Agricultural Material

(71) Applicant: Ryan Bruce Meyer, Hamler, OH (US)

(72) Inventor: Ryan Bruce Meyer, Hamler, OH (US)

(21) Appl. No.: 13/852,001

(22) Filed: Mar. 28, 2013

(51) Int. Cl. B62B 1/22

(52) U.S. Cl. CPC B62B 1/22
USPC 280/47.3

(57) ABSTRACT

A device to move material comprises a front frame comprising an axle extension, a wheel connected to the front frame via an axle connected to the axle extension, and two arms rotatably connected to the front frame via hinges, each arm rotatable about an axis that is substantially perpendicular to a length of the front frame and a length of the each arm so as to define an arm closing swinging direction and an arm opening swinging direction for the each arm. The device further comprises two handles, each handle connected to an end of each of the two arms, and a plurality of gripping extensions connected to the two handles, wherein each arm comprises at least two of the gripping extensions located at an arm closing swinging direction of the each arm.

### BACKGROUND OF THE INVENTION

The present invention relates to a way to easily and effortlessly move a bale of hay or straw.

Many horse and cattle farms still use small square bales of hay. It is very difficult picking up and moving a heavy bale to a different location.

As can be seen, there is a need for solutions to this and other problems.

### SUMMARY OF THE INVENTION

In one aspect of the present invention, a device to move material comprises: a front frame comprising an axle extension; a wheel connected to the front frame via an axle connected to the axle extension; two arms rotatably connected to the front frame via hinges, each arm rotatable about an axis that is substantially perpendicular to a length of the front frame and a length of the each arm so as to define an arm closing swinging direction and an arm opening swinging direction for the each arm; two handles, each handle connected to an end of each of the two arms; and a plurality of gripping extensions connected to the two handles, wherein each arm comprises at least two of the gripping extensions located at an arm closing swinging direction of the each arm, whereby moving the each arm in the arm closing swinging direction toward the material causes the at least two of the gripping extensions to contact the material. In one aspect, the two arms are substantially straight. In one aspect, the two arms and the plurality of gripping extensions are approximately planar. In one aspect, each arm comprises at least four of the gripping extensions spaced out over a total distance of at least approximately two feet. In one aspect, the plurality of gripping extensions comprises spikes. In one aspect, the hinges comprise bolts passing through holes in the front frame and arms.

In one aspect, a method of moving material comprises: providing the device as described; opening the two arms by swinging each arm in its respective arm opening swinging direction; abutting the front frame against the material; closing the two arms by swinging each arm in its respective arm closing swinging direction to thereby cause the plurality of gripping extensions to contact the material; lifting the handles to thereby lift the material; and pushing the device to cause the wheel to rotate. In one aspect, the material comprises a bale of agricultural material.

These and other features, aspects and advantages of the present invention will become better understood with reference to the following drawings, description and claims.

### BRIEF DESCRIPTION OF THE DRAWINGS

FIG. 1: is a perspective view of one embodiment of the invention in use.

FIG. 2: is a perspective view of one embodiment of the invention.

FIG. 3: is a top view of one embodiment of the invention.

FIG. 4: is a side view of one embodiment of the invention.

FIG. 5: is an exploded view of one embodiment of the invention.

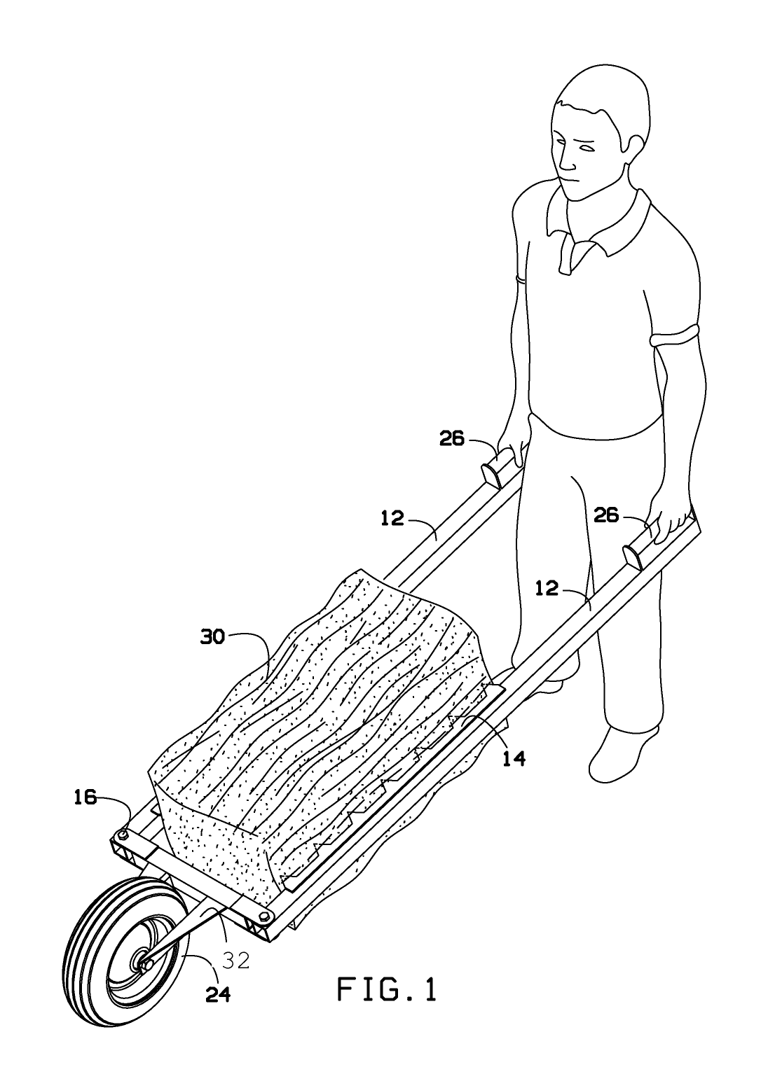

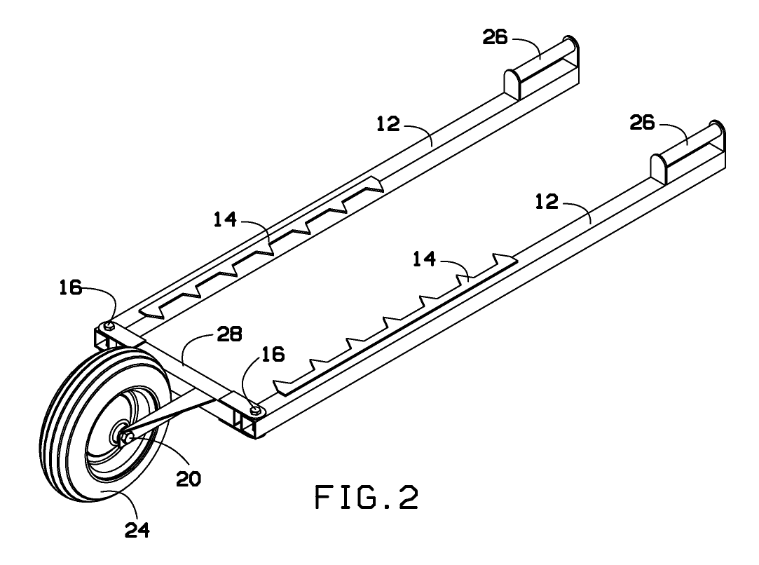

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the figures, the following reference numbers may refer to elements of the invention:

12: are the arms.

14: are the gripping extensions.

16: are the hinges.

18: are the hinge nuts.

20: is the axle.

22: is the axle nut.

24: is the wheel.

26: are the handles.

28: is the front frame.

30: is the hay bale.

32: is the axle extension.

The present device is low profile and picks up the hay bale at a low level, which is easier on a user's back. It also transports the bale smoothly and without much effort. It improves on moving a bale by making the lifting aspect much easier. It also makes moving it easier because one is pushing it around instead of carrying it.

This hand held invention may have a wheel on one end and handles on the other. It squeezes the bales and acts as a lever to pick the bale up with ease. It can then be pushed around to the designated point and the bales can be released.

When using the present invention one first must have a bale of hay or straw or other agricultural material on the ground. One then spreads the arms of the unit, then proceeds by backing up to the bale so the front bar is touching or almost touching the bale. After that is completed the user bends down so the arms are equal with the middle (or an area near a central part) of the bale. The user proceeds by squeezing the arms together and standing up. The bale is now ready for transport and the bale can be pushed to the desired location. When one has reached the desired location, the user can simply bend down (so the bale is on the ground) and spread the arms out again. The user leaves the bale there by pushing the unit forward. The unit is now ready to repeat the process as much as needed.

Another aspect of the present invention may include the following method steps:

1. Bend down and grab both handles.
2. Push the device over to where the bale is.
3. Spread the arms out.
4. Back up so the front bar is touching or almost touching the bale.
5. Bend down so the spikes are almost equal with the middle of the bale or lower.
6. Squeeze the handles together.
7. With the handles squeezed together stand up.
8. Push the invention and bale to the desired location.
9. Bend down so the bale is on the ground.
10. Spread the handles out.
11. Stand up and push the invention away from the bale.
12. Repeat as necessary.

Another aspect of the present invention may include the following method of building a device:

1. Cut arms at a length of between approximately 50 and 80 inches, such as 64 inches, out of any rigid material, such as wood, metal tubing (e.g., two inch square metal tubing), etc.
2. Cut four pieces of flat stock that is approximately three inches long and two inches wide, although other sizes are within the scope of the invention.
3. Create two handles out of any rigid material, such as wood, metal, or pipe (e.g., one-inch steel pipe).
4. Weld or attach one piece of flat stock to each end of the pipe facing in the same direction.
5. Weld or attach the other end of the flat stock to the top of one arm on the end and repeat this process. This creates a handle on one end of each arm.
6. Cut several (e.g., at least four, such as eight) spikes several inches long (e.g., four inches) and sharpen one end of the spikes.
7. Drill holes through the arms at the opposite end as the handles. The holes may start about five inches in and may be spaced about eight inches, allowing the spikes to go through.
8. With the handles facing up and the holes side to side, the builder may put the spikes through the holes so the sharp end is facing in. These will eventually poke into the bale.
9. Weld or attach the end of the spike to the arms so they are permanently connected.
10. Cut a front bar of a length between approximately 10 and 20 inches, such as 16 inches.
11. Cut several (such as five) pieces of flat stock that is approximately 2 by 5 inches, although other sizes are within the scope of the invention.
12. Weld or attach the flat stock on top and bottom of the front bar on each side and make sure that they are hanging over each end a sufficient length, such as over two inches.
13. Put the arms in between the flat stock on each side. This is where the hinge will be created.
14. Drill a hole through the flat stock and the arms on both sides.
15. Insert a bolt and put a nut on and tighten until there is pressure.
16. Both arms may now be hinged to the front bar.
17. Cut two nine inch angle iron pieces.
18. Drill or punch one hole on each angle iron, such as about 0.75 inch wide, although other lengths are within the scope of the invention. This is where the bolt will go that acts as a front axle.
19. Weld or attach them to the front bar on the outside of the unit. Weld or attach the ends that don't have the holes.
20. Place the tire (e.g., a 4 by 16 inch tire) in between the front bars.
21. Put the ¾ inch bolt through the front supports and the rim of the tire.
22. Place a nut on the end of bolt. The front axle is now in place. (A spacer may be placed on each side of the tire.) A second tire could be added if one wanted to make the unit more stable when pushing the bale around.

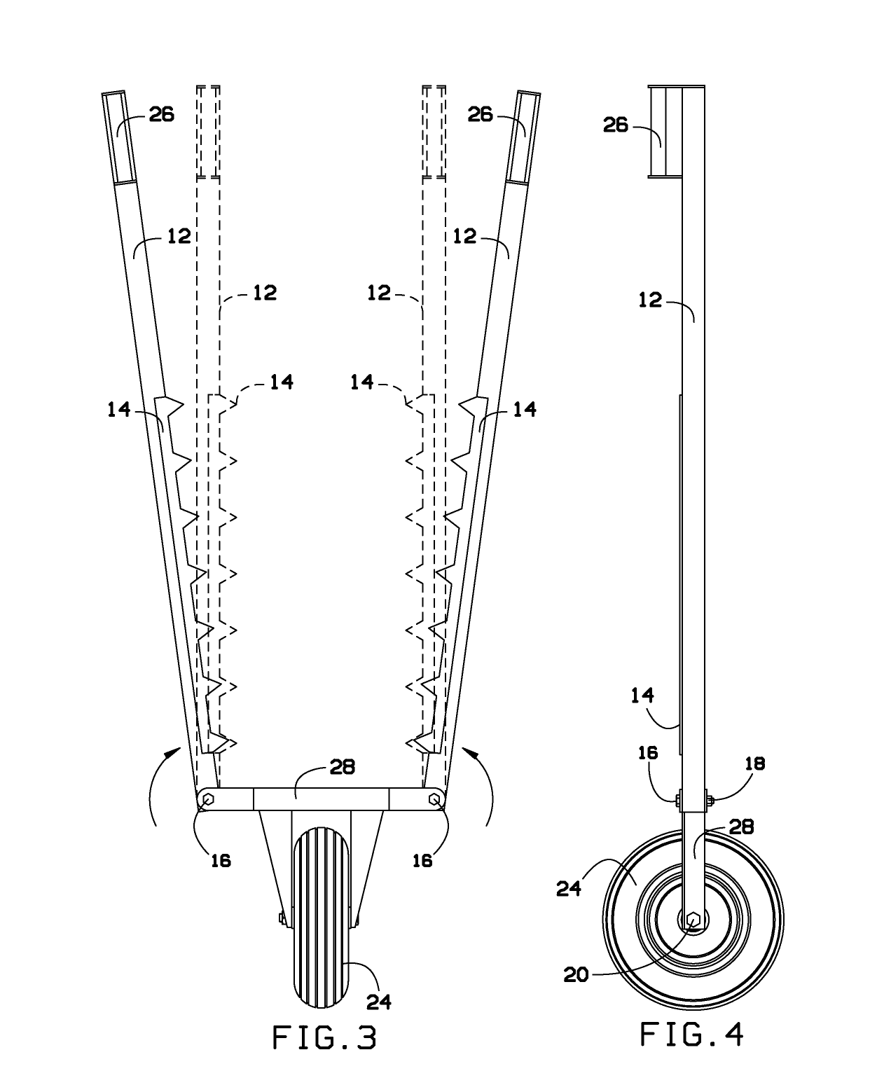

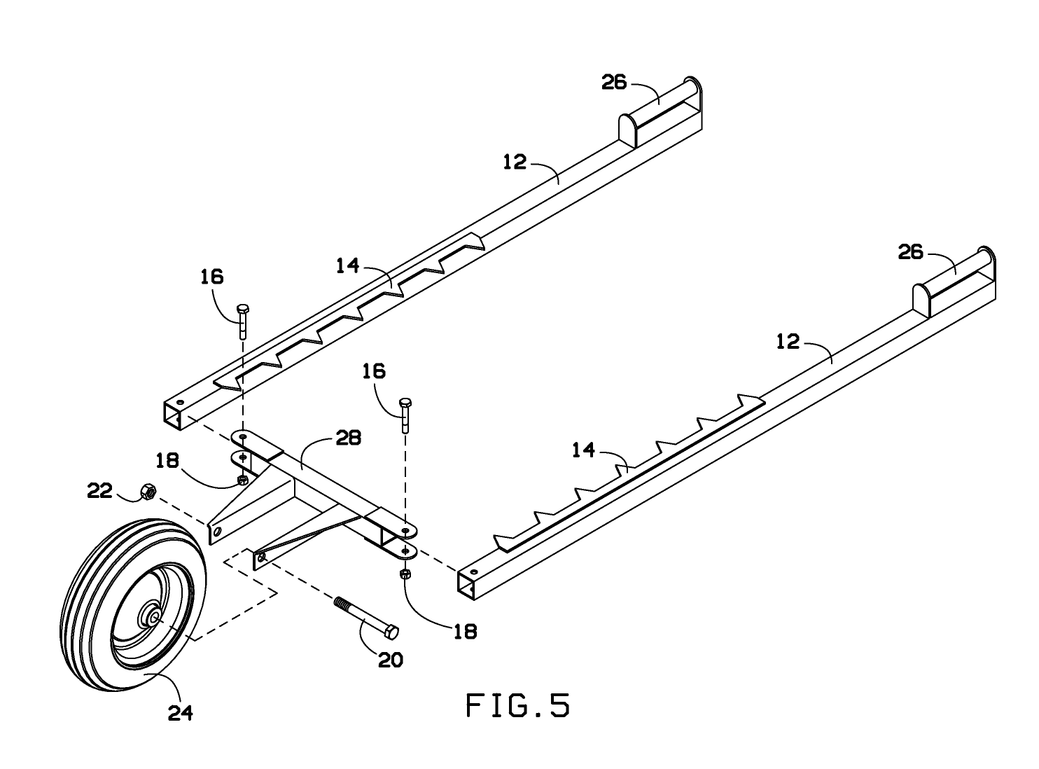

Referring now to the drawings, in one aspect of the present invention, a device to move material comprises: a front frame 28 comprising an axle extension 32, a wheel 24 connected to the front frame 28 via an axle 20 connected to the axle extension 32, and two arms 12 rotatably connected to the front frame 32 via hinges 16, each arm 12 rotatable about an axis that is substantially perpendicular to a length of the front frame 28 and a length of the each arm 12 so as to define an arm closing swinging direction and an arm opening swinging direction for the each arm. For example, as shown in FIG. 3, the hinge 16 comprises a bolt passing through holes in the arms 12 and front frame 28. In this example, the length of each arm 12 and the length of the front frame 28 intersect at respective hinge 16, substantially forming a plane (as the intersection of two non-identical lines defines a plane), and the bolt creating hinge 16 is substantially perpendicular this plane, allowing the arms 12 to swing in a direction along this plane, defining an arm closing swinging direction and an arm opening swinging direction for each of the arms 12. In FIG. 3, the dotted lines represent the locations of the arms 12 in an engaged position after they have been swing in the arm closing swinging direction to thereby engage the material, such as the hay bale 30.

The device further comprises two handles 26, each handle connected to an end of each of the two arms 12, and a plurality of gripping extensions 14 connected to the two handles, wherein each arm 12 comprises at least two of the gripping extensions 14 located at an arm closing swinging direction of the each arm, whereby moving the each arm 12 in the arm closing swinging direction toward the material (such as hay bale 30) causes the at least two of the gripping extensions 14 to contact the material. The extensions 14 could be spikes, blades, or other protrusions that enable gripping of the material.

In one aspect, the two arms 12 are substantially straight, but may be curved or designed differently. In one aspect, the two arms 12 and the plurality of gripping extensions 14 are approximately planar, and arms 12 may rotate within a plane, so that when the arms 12 are swing in their respective arm closing swinging directions, the gripping extensions 14 grip the material.

In one aspect, each arm 12 comprises at least four (or six or eight) of the gripping extensions 14 spaced out over a total distance of at least approximately one foot, 18 inches, or two feet.

It should be understood, of course, that the foregoing relates to exemplary embodiments of the invention and that modifications may be made without departing from the spirit and scope of the invention.

1. A device to move material, comprising:
a front frame comprising an axle extension;
a wheel connected to the front frame via an axle connected to the axle extension;
two arms rotatably connected to the front frame via hinges, each arm rotatable about an axis that is substantially perpendicular to a length of the front frame and a length of the each arm so as to define an arm closing swinging direction and an arm opening swinging direction for the each arm;
two handles, each handle connected to an end of each of the two arms; and
a plurality of gripping extensions connected to the two handles,
wherein a plane formed along the length of the two arms intersects with the diameter of the wheel,
wherein each arm comprises at least two of the gripping extensions located at an arm closing swinging direction of the each arm, wherein each of the at least two gripping extensions are positioned along a different portion of the length of each arm, whereby moving the each arm in the arm closing swinging direction toward the material causes the at least two of the gripping extensions to contact the material.

2. The device as claimed in claim 1, wherein the two arms are substantially straight.

3. The device as claimed in claim 1, wherein the two arms and the plurality of gripping extensions are approximately planar.

4. The device as claimed in claim 1, wherein each arm comprises at least four of the gripping extensions spaced out over a total distance of at least approximately two feet.

5. The device as claimed in claim 1, wherein the plurality of gripping extensions comprises spikes.

6. The device as claimed in claim 1, wherein the hinges comprise bolts passing through holes in the front frame and arms.

7. A method of moving material, comprising:
providing the device as claimed in claim 1;
opening the two arms by swinging each arm in its respective arm opening swinging direction;
abutting the front frame against the material;
closing the two arms by swinging each arm in its respective arm closing swinging direction to thereby cause the plurality of gripping extensions to contact the material;
lifting the handles to thereby lift the material; and
pushing the device to cause the wheel to rotate.

8. The method as claimed in claim 7, wherein the material comprises a bale of agricultural material.

9. A device to move material, comprising:
a front frame comprising an axle extension;
a wheel connected to the front frame via an axle connected to the axle extension;
two arms rotatably connected to the front frame via hinges, each arm rotatable about an axis that is substantially perpendicular to a length of the front frame and a length of the each arm so as to define an arm closing swinging direction and an arm opening swinging direction for the each arm;
two handles, each handle connected to an end of each of the two arms; and
a plurality of gripping extensions connected to the two handles,
wherein the two arms and the axle are approximately planar,
wherein each arm comprises at least two of the gripping extensions located at an arm closing swinging direction of the each arm, wherein the at least two gripping extensions on each arm form a line between one another substantially parallel with the length of each arm, whereby moving the each arm in the arm closing swinging direction toward the material causes the at least two of the gripping extensions to contact the material.
